(19) United States
(12) Patent Application Publication
(10) Pub. No.: US 2006/0139439 A1
(43) Pub. Date: Jun. 29, 2006

(54) Inner drum-type multibeam exposure method and inner drum exposure apparatus

(75) Inventor: Ichirou Miyagawa, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/311,287

(22) Filed: Dec. 20, 2005

(30) Foreign Application Priority Data
Dec. 28, 2004 (JP) 2004-381975

(51) Int. Cl. B41J 2/435

(52) U.S. Cl. 347/224

(57) ABSTRACT

An inner drum-type multibeam exposure method includes: (a) controlling deflection, with light-deflecting means, of at least one of a plurality of light beams, which are respectively independently modulated in accordance with image signals and emitted from a light source side; (b) making the deflection-controlled light beam incident at scanning means via one of a reflection portion and a transmission portion provided at a sectional optical function member, and making another of the light beams, which is not deflection-controlled by the light-deflecting means, incident at the scanning means via the other of the reflection portion and the transmission portion; and (c) with the scanning means, scanning for exposure on a recording medium disposed at a support body of an inner drum, while a sub-scanning direction spacing between the plurality of light beams is maintained at a predetermined distance. With this method, high-speed exposure processing without losses of light amounts is possible.

### CROSS-REFERENCE TO RELATED APPLICATION

This application claims priority under 35 USC 119 from Japanese Patent Application No. 2004-381975, the disclosure of which is incorporated by reference herein.

### BACKGROUND OF THE INVENTION

1. Field of the Invention

The present invention relates to an inner drum-type multibeam exposure method for scanning and exposure-processing a photosensitive surface, which is disposed at an inner face of a cylindrical drum, with a light beam scanning optical system, and to an inner drum exposure apparatus (an inner face scanning-type light beam scanning-exposure apparatus).

2. Description of the Related Art

In general, inner drum exposure apparatuses (inner face scanning-type light beam scanning-exposure apparatuses) which direct a light beam such as a laser or the like with an optical deflector, to perform scanning for exposure processing at a photosensitive surface of a recording medium which is disposed on an inner peripheral face of a cylindrical drum, are widely used. Recording mediums at which images are to be scanning-exposed and recorded are loaded at an automatic developing machine in accordance with requirements, and latent images that are formed on the recording mediums are converted to manifest images. In order to enable high-speed exposure processing, it is desirable to realize such inner drum exposure apparatuses as multibeam apparatuses.

For a conventional inner drum exposure apparatus, designs which increase speed of output by pluralizing scanning beams are known. In such a case, it is necessary for scanning lines formed by the plural light beams to be straight lines which are parallel with one another and evenly spaced. Furthermore, it is desirable for concurrent writing points of the respective beams to be aligned in a sub-scanning direction. Accordingly, deflection with acoustic optical devices (“AOD”) has been known (see, for example, Japanese Patent Application Laid-Open (JP-A) No. 10-170848).

At an exposure-scanning system of such an inner drum exposure apparatus, in order to achieve high-speed exposure, it is necessary to realize a multibeam structure. As a technique for implementing such a multibeam system, means for employing deflection devices (AODs, EODs and the like) for realizing a multibeam structure have been considered. With a means for realizing a multibeam structure by using such deflection devices, it is possible to multiplex without losses of light amounts by employing polarized light of lights from up to two beams. However, if there are three or more beams, it is necessary to employ a beam splitter, a half-mirror or the like for multiplexing, and there is a disadvantage in that at least half of a light amount is wasted.

Consequently, if, for example, exposure processing is performed in conditions in which a photosensitive material which is a recording medium has a maximum photosensitivity and output power of light sources is maximized, half or more of light amounts is wasted as described above, and a problem arises in that insufficiencies of light amounts occur and a speed of writing onto the recording medium is lowered.

### SUMMARY OF THE INVENTION

In light of the problem described above, an object of the present invention is to provide an inner drum-type multibeam exposure method and multibeam-system inner drum exposure apparatus in which scanning for exposure processing is performed by directing a plurality of light beams at a photosensitive surface of a recording medium disposed on an inner peripheral face of a cylindrical drum with low losses of light amounts, and which enable high-speed exposure processing.

In a first aspect of the present invention, an inner drum-type multibeam exposure method includes the steps of: deflectively controlling, with light-deflecting means, at least one of a plurality of light beams, which light beams are respectively independently modulated in accordance with image signals and emitted from a light source side; condensing the deflection-controlled light beam and another of the light beams at a respective reflection portion and transmission portion, which are provided at different positions of a sectional optical function member, and, with the sectional optical function member, reflecting at least one of the light beams at the reflection portion and transmitting each other of the light beams through the transmission portion for specifying an optical path of the another light beam and an optical path of the deflection-controlled light beam so as to be incident at scanning means; and scanning for exposure on a recording medium which is disposed at a support body of an inner drum, while the scanning means maintains a predetermined spacing between the plurality of light beams in a sub-scanning direction.

According to the inner drum-type multibeam exposure method described above, at least two light beams, which are respectively independently modulated on the basis of image signals, are emitted from the light source side. By utilization of the sectional optical function member, the light beams are respectively directed to the scanning means, with low losses of light amounts, for performing scanning for exposure processing. Thus, high-speed exposure processing with a multibeam structure is possible.

In a second aspect of the present invention, an inner drum exposure apparatus includes: a plurality of optical systems at a light source side, for emitting light beams which are modulated in accordance with image signals; light-deflecting means disposed on an optical path of at least one of the plurality of light source side optical systems so as to control deflection of a light beam; a condensing lens which condenses the light beam that has been deflection-controlled by the light-deflecting means; a condensing lens which condenses a light beam emitted from the plurality of light source side optical systems other than the deflection-controlled light beam; a sectional optical function member, which is disposed such that a focusing position of the light beam that has been deflection-controlled by the light-polarizing means and a focusing position of the light beam emitted from the plurality of light source side optical systems which is not the deflection-controlled light beam correspond with a reflection portion and a transmission portion which are provided at different positions of the sectional optical function member, the sectional optical function member reflecting at least one of the-light beams at the reflection portion and transmitting each other of the light beams through the transmission portion, for specifying an optical path of the light beam emitted from the plurality of light source side optical systems which is not the deflection-controlled light beam and an optical path of the deflection-controlled light beam so as to be incident at scanning means; and the scanning means, which, while maintaining a predetermined spacing in a sub-scanning direction between the plurality of light beams that have passed along optical paths specified by the sectional optical function member and are incident at the scanning means, focuses the plurality of light beams onto a recording medium disposed at a support body of an inner drum and performs scanning for exposure.

According to the structure described above, at least two light beams which are modulated on the basis of image signals are emitted from the plural optical systems at the light source side. By utilization of the condensing lens and the sectional optical function member, the light beams are gathered to an optical path of the plural light beams and, such that losses of respective light amounts thereof do not occur, are directed to the scanning means. Then, the scanning means, while maintaining the predetermined spacing in the sub-scanning direction between the light beams which are incident thereat from the sectional optical function member side thereof, focuses the light beams on the recording medium disposed at the support body of the inner drum and performs scanning for exposure. Thus, high-speed exposure processing with a multibeam structure is possible.

In a third aspect of the present invention, the inner drum exposure apparatus of the second aspect further includes at least one combination of a plurality of types of optical member, the combination of optical members including: a condensing lens which condenses the plurality of light beams that have passed along the optical paths specified by the sectional optical function member; light-deflecting means for controlling deflection of either a light beam from one of the light sources, which has been modulated in accordance with the image signals, or light beams from two of the light sources, which have been respectively modulated in accordance with the image signals and have been polarized and coaxially multiplexed; a condensing lens which condenses the light beam that has been deflection-controlled by the light-deflecting means; and another sectional optical function member, which is disposed such that a focusing position of the plurality of light beams that have passed along the optical paths specified by the sectional optical function member and a focusing position of the light beam that has been deflection-controlled by the light-deflecting means correspond with a reflection portion and a transmission portion which are provided at different positions of the other sectional optical function member, the other sectional optical function member reflecting at least one light beam at the reflection portion and transmitting each other of the light beams through the transmission portion, for specifying an optical path of the plurality of light beams that have passed along the optical paths specified by the sectional optical function member and an optical path of the light beam that has been deflection-controlled by the light-deflecting means, wherein the at least one combination of optical members is disposed on an optical path at an upstream side relative to the scanning means, for specifying multibeam in multiple stages.

According to the third aspect described above, a number of beams that it is possible to multiplex without losses of light amounts is increased, and it is possible to further promote realization of a multibeam structure. Thus, in addition to the operations and effects of the second aspect, exposure processing at even higher speeds is possible.

In a fourth aspect of the present invention, the sectional optical function member of an inner drum exposure apparatus based on the second or third aspect is formed with the transmission portion in an elliptical shape in plan view and the reflection portion being formed around the transmission portion, the transmission portion transmitting the light beam in a condensed state, and the reflection portion reflecting the light beam that has been deflection-controlled by the light-deflecting means in a condensed state.

In a fifth aspect of the present invention, the sectional optical function member of an inner drum exposure apparatus based on the second or third aspect is formed with the reflection portion in an elliptical shape in plan view and the transmission portion being formed around the reflection portion, the reflection portion reflecting the light beam in a condensed state, and the transmission portion transmitting the light beam that has been deflection-controlled by the light-deflecting means in a condensed state.

In a sixth aspect of the present invention, the sectional optical function member of an inner drum exposure apparatus based on the second or third aspect is divided in two with a linear boundary, one section thereof structuring the transmission portion for transmitting the light beam condensed thereat, and the other section thereof structuring the reflection portion for reflecting the light beam condensed thereat.

In a seventh aspect of the present invention, an inner drum exposure apparatus based on any of the second to sixth aspects is structured such that at least two of the light beams of the plurality of light source side optical systems are polarized and multiplexed by a polarizing beam splitter and are then transmitted through a quarter-wavelength plate to be circularly polarized, the light beams which have been polarized and multiplexed and converted to circularly polarized light are converted to light beams with mutually intersecting linear polarizations by another quarter-wavelength plate, the light beams with mutually intersecting linear polarizations are separated by a uniaxial crystal which is disposed at the scanning means side, and the light beams are focused on the recording medium with the predetermined spacing in the sub-scanning direction opened therebetween.

According to the present aspect, by combining means for utilizing polarization to realize a multibeam structure, a number of beams that it is possible to multiplex without losses of light amounts is increased, and it is possible to further promote realization of a multibeam structure. Thus, in addition to the operations and effects of the second to sixth aspects, exposure processing at even higher speeds is possible.

In an eighth aspect of the present invention, an inner drum exposure apparatus based on the seventh aspect is structured such that a polarization control element and a splitting element are disposed at an optical path downstream side relative to the uniaxial crystal, the polarization control element controlling a polarization direction of each light beam, and the splitting element splitting the each light beam which has passed through the polarization control element in the sub-scanning direction, the each light beam being split in the sub-scanning direction into substantially equal light amounts.

According to the structure of the present aspect, the respective light beams are split, using respective polarization control elements and splitting elements, such that focusing spots with equivalent light amounts are adjacent and overlapping in the sub-scanning direction.

Hence, it is possible to make the respective light beams closer to a rectangular shape with respect to the sub-scanning direction, and it is possible to form spot shapes with well-defined states which are narrowed with respect to the main scanning direction. Consequently, it is possible to raise the quality of recorded pixels.

According to the inner drum-type multibeam exposure method and the multibeam-system inner drum exposure apparatus of the present invention, it is possible to perform scanning for exposure processing by directing a plurality of light beams at a recording surface of a recording medium, which is disposed on an inner peripheral face of a cylindrical drum, with low losses of light amounts. Thus, there is an effect in that high-speed exposure processing is possible.

### BRIEF DESCRIPTION OF THE DRAWINGS

FIG. 1 is a schematic structural view showing an inner drum exposure apparatus relating to a first embodiment of the present invention.

FIG. 2 is an explanatory view showing schematics of structure of optical paths reaching from light sources to a spinner mirror device, which is employed in the inner drum exposure apparatus relating to the first embodiment of the present invention.

FIG. 3 is an enlarged perspective view particularly showing a sectional optical function member which is disposed on the optical paths reaching from the light sources to the spinner mirror device, which is employed in the inner drum exposure apparatus relating to the first embodiment of the present invention.

FIG. 4 is an explanatory view showing another structural example relating to the optical paths reaching from the light sources to the spinner mirror device, which is employed in the inner drum exposure apparatus relating to the first embodiment of the present invention.

FIG. 5 is an enlarged perspective view particularly showing another structural example of the sectional optical function member of the optical paths reaching from the light sources to the spinner mirror device, which is employed in the inner drum exposure apparatus relating to the first embodiment of the present invention.

FIG. 6 is an enlarged perspective view particularly showing yet another structural example of the sectional optical function member of the optical paths reaching from the light sources to the spinner mirror device, which is employed in the inner drum exposure apparatus relating to the first embodiment of the present invention.

FIG. 7 is an explanatory view showing yet another structural example of the optical paths reaching from the light sources to the spinner mirror device, which is employed in the inner drum exposure apparatus relating to the first embodiment of the present invention.

FIG. 8 is an explanatory view showing schematics of structure of optical paths reaching from light sources to a spinner mirror device, which is employed in an inner drum exposure apparatus relating to a second embodiment of the present invention.

FIG. 9 is an explanatory view showing another structural example of the optical paths reaching from the light sources to the spinner mirror device, which is employed in the inner drum exposure apparatus relating to the second embodiment of the present invention.

FIGS. 10A, 10B and 10C are enlarged perspective views showing sectional optical function members of the other structural example of the optical paths reaching from the light sources to the spinner mirror device which is employed in the inner drum exposure apparatus relating to the second embodiment of the present invention.

FIG. 11 is an explanatory view showing structure of light beam separation elements and splitting elements which are mounted at the spinner mirror device, which are employed in the inner drum exposure apparatus relating to the second embodiment of the present invention.

FIG. 12 is an explanatory view showing characteristics of a uniaxial crystal optical element, which is employed in an inner drum exposure apparatus relating to the first embodiment or second embodiment of the present invention.

FIG. 13 is an explanatory view showing characteristics of a uniaxial crystal optical element of another structure, which can be employed in an inner drum exposure apparatus relating to the first embodiment or second embodiment of the present invention.

FIG. 14 is an explanatory view showing a locus, in a plane S′ which intersects a rotation axis of the spinner mirror device, of a laser beam which is deflected by light-deflecting means which deflects in an X-axis direction and a Y-axis direction, which is employed in an inner drum exposure apparatus relating to the first embodiment or second embodiment of the present invention.

FIG. 15 is an explanatory view showing structure of a control circuit for the light-deflecting means which deflect in the X-axis direction and the Y-axis direction, which is employed in the inner drum exposure apparatus relating to the first embodiment or second embodiment of the present invention.

### DETAILED DESCRIPTION OF THE INVENTION

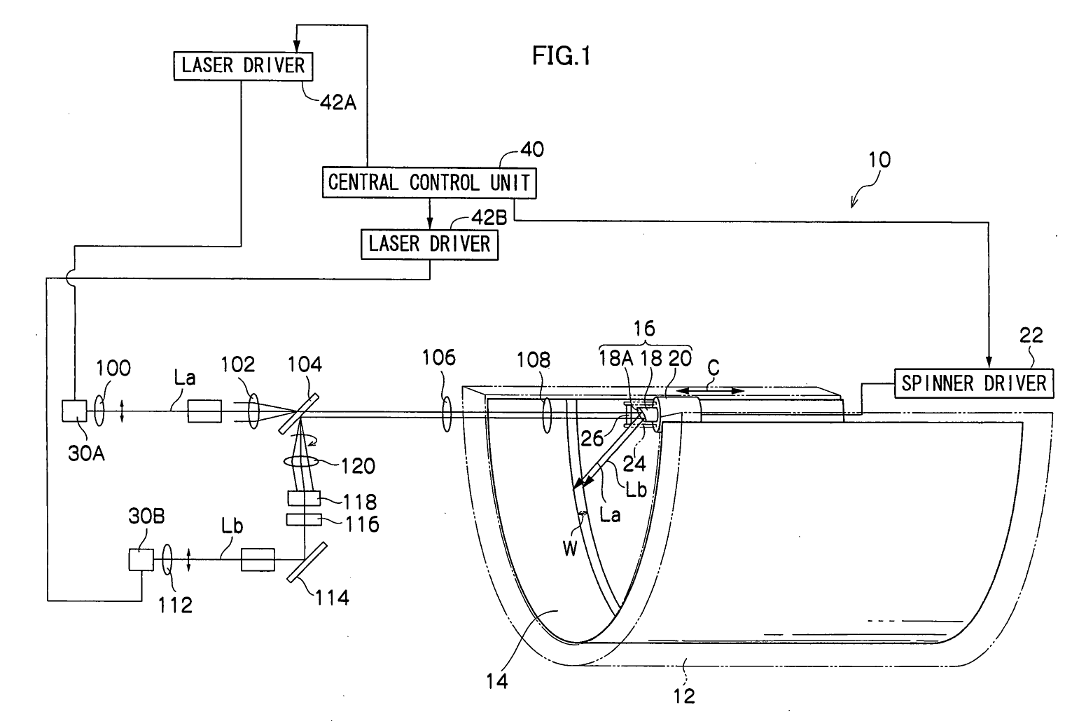

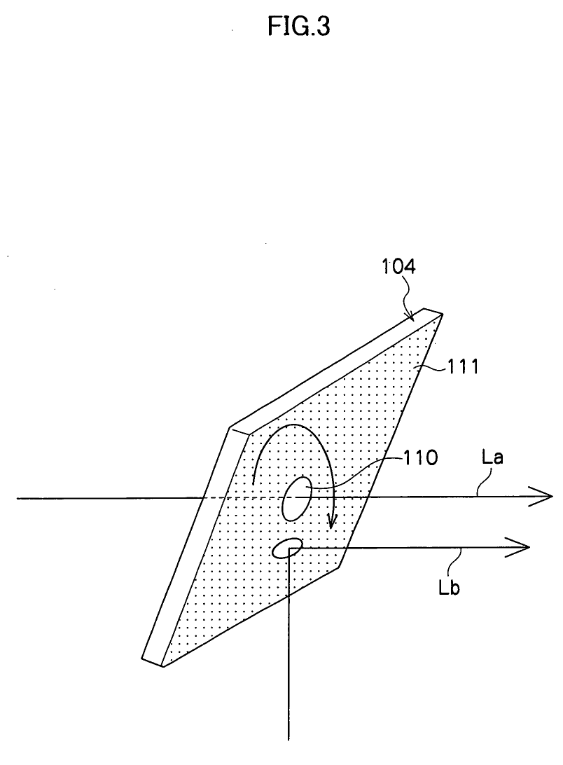

A first embodiment relating to an inner drum exposure apparatus of the present invention will be described with reference to FIGS. 1 to 7. As shown in the schematic structural diagram of FIG. 1, an inner drum exposure apparatus 10 is structured with a support body 12 with a circular arc-form inner peripheral surface (i.e., a shape constituting a portion of an inner peripheral face of a circular tube) serving as a principal body thereof. A recording medium 14 (a photopolymer plate, an ordinary photosensitive plate, a silver salt-type photosensitive material or the like) is supported along the inner peripheral surface of the support body 12.

At this inner drum exposure apparatus 10, the unrecorded recording medium 14 is supplied by an unillustrated supply and ejection apparatus for the recording mediums 14, is anchored in a state of being assuredly closely adhered along the inner peripheral face of the support body 12, and then exposure processing is performed. Then, an operation to eject the exposure-processed recording medium 14 from the support body 12 to outside is performed.

In this inner drum exposure apparatus 10, a spinner mirror device 16, which serves as scanning means (i.e., an optical deflector), is disposed at a center position of the circular arc of the support body 12. This spinner mirror device 16 is structured with a rotating shaft member 18, which can be rotated about a central axis thereof (which coincides with a central axis of the circular arc of the support body 12) by a motor 20 which is a drive source.

A reflection mirror surface 18A, which forms an angle of 45° with the rotation axis, is formed at a distal end portion of the rotating shaft member 18 of the spinner mirror device 16 which is the optical deflector. This spinner mirror device 16 serving as the scanning means is moved at a constant speed in the axial direction of the central axis of the circular arc of the support body 12 (the direction of arrow C in FIG. 1) by unillustrated sub-scanning movement means. Control of rotation of the motor 20 of the spinner mirror device 16 is performed by a spinner driver 22.

As shown in FIG. 1, at this inner drum exposure apparatus 10, for main-scanning over a recording surface of the recording medium 14 with a multibeam system, a light source side optical system is provided which projects multibeams (a plurality of light beams) toward the spinner mirror device 16.

This light source side optical system is provided with a pair of first and second semiconductor laser light sources (laser diodes) 30A and 30B (i.e., light beam outputting means) and respective condensing optical systems. The first and second semiconductor laser light sources 30A and 30B output laser beams La and Lb with modulated light amounts, which are constituted as substantially linearly polarized lights. The condensing optical systems focus the laser beams La and Lb which are outputted, respectively, from the first and second semiconductor laser light sources 30A and 30B onto the recording surface of the recording medium 14. For this pair of first and second semiconductor laser light sources 30A and 30B, single-longitudinal-mode semiconductor lasers can be employed, with respective intensity distributions in which a central light intensity is high and the light intensity gradually becomes lower away from the center.

The optical system of the first semiconductor laser light source 30A is structured with a collimating lens (collimator lens) 100, a beam-shaping optical member 101 for modifying a beam shape, a condensing lens 102, a sectional optical function member 104, a collimating lens (collimator lens) 106 and a condensing lens 108 arranged in this order from the first semiconductor laser light source 30A side of the optical system.

The sectional optical function member 104 is structured to transmit the light beam irradiated from one of the pair of first and second semiconductor laser light sources 30A and 30B and thus direct this light beam toward the spinner mirror device 16, and to reflect the light beam irradiated from the other laser light source and thus direct this light beam toward the spinner mirror device 16.

Specifically, at the sectional optical function member 104 shown in FIGS. 1 to 3, structure is such that the light beam irradiated from the first semiconductor laser light source 30A is directed toward the spinner mirror device 16 by being transmitted (passed through) and the light beam irradiated from the second semiconductor laser light source 30B is directed toward the spinner mirror device 16 by being reflected.

Accordingly, the sectional optical function member 104 is formed with a transparent section, which is circular in a front elevational view of a state in which the sectional optical function member 104 is inclined at a predetermined angle, at a central portion thereof. This transparent section serves as a transparent portion 110 which allows the laser beam La emitted from the first semiconductor laser light source 30A to pass therethrough. In addition, a whole surface of the sectional optical function member 104 apart from the transparent portion 110 (or possibly a predetermined range around the transparent portion 110) constitutes a reflective portion (a reflection surface) 111.

Herein, this sectional optical function member 104 as shown in FIGS. 1 to 3 may have various structures, such as a structure in which the sectional optical function member 104 as a whole is formed by a transparent glass plate and the whole surface thereof apart from the transparent portion 110 at the center is machined to a mirror surface, or the like. Alternatively, the transparent portion 110 may be formed as an aperture.

This sectional optical function member 104 is disposed such that the transparent portion 110 is at a focusing position of the condensing lens 102 and the reflective portion 111 is at a focusing position of a condensing lens 120.

The optical system of the second semiconductor laser light source 30B is structured with a collimating lens (collimator lens) 112, a beam-shaping optical member 111 for modifying a beam shape, a reflection mirror 114, an acoustic optical device 116, an acoustic optical device 118, the condensing lens 120, and the shared sectional optical function member 104, collimating lens 106 and condensing lens 108 arranged in this order from the second semiconductor laser light source 30B of the optical system. The acoustic optical device 116 is light-deflecting means (a microdeflector) for controlling deflection of a light beam in an X-axis direction with respect to the spinner mirror device 16. The acoustic optical device 118 is light-deflecting means (a microdeflector) for controlling deflection of the second laser beam Lb in a Y-axis direction.

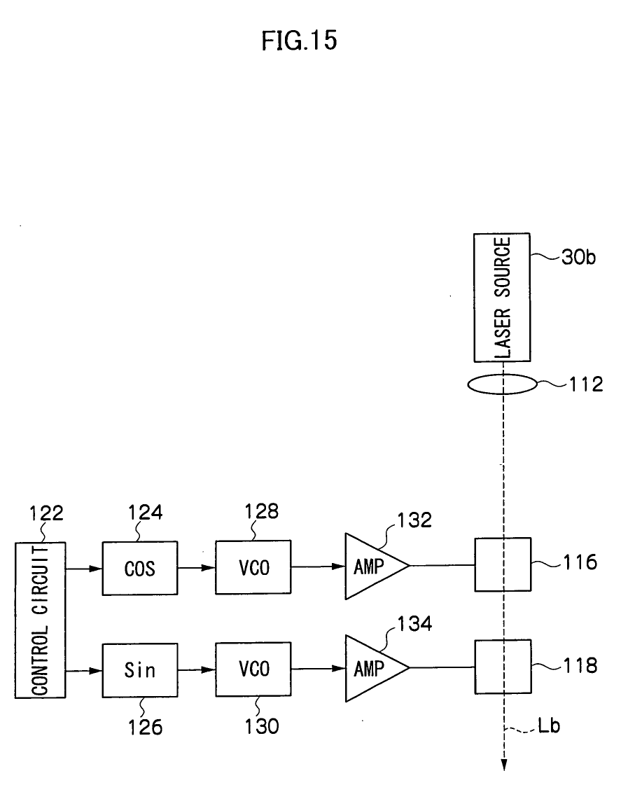

The acoustic optical device 116 and acoustic optical device 118 which are light-deflecting means are respectively controlled by a circuit shown in FIG. 15. This circuit, which serves as controlling means, is provided with a control circuit 122, a cosine wave signal generation circuit 124, a sine wave signal generation circuit 126, a voltage-controlled oscillator 128, a voltage-controlled oscillator 130, an amplifier 132, and an amplifier 134. The control circuit 122 generates a control clock signal on the basis of signals from an unillustrated encoder which is provided at the spinner mirror device 16. The cosine wave signal generation circuit 124 generates a cosine wave voltage signal in accordance with the control clock signal. The sine wave signal generation circuit 126 generates a sine wave voltage signal in accordance with the control clock signal. The voltage-controlled oscillator 128 creates a frequency-modulated signal from the cosine wave voltage signal. The voltage-controlled oscillator 130 creates a frequency-modulated signal from the sine wave voltage signal. The amplifier 132 amplifies the frequency-modulated signal from the voltage-controlled oscillator 128 and supplies the amplified signal to the acoustic optical device 116. The amplifier 134 amplifies the frequency-modulated signal from the voltage-controlled oscillator 130 and supplies the amplified signal to the acoustic optical device 118.

At the second semiconductor laser light source 30B side optical system which is structured as described above, the laser beam Lb which is outputted from the second semiconductor laser light source 30B is deflected by the acoustic optical device 116 and the acoustic optical device 118, which are the light-deflecting means and are controlled by the controlling means, is focused at the reflective portion 111 of the sectional optical function member 104 by the condensing lens 120, and is reflected. Further, in this structure, the laser beam Lb is made parallel with the laser beam La by the collimating lens 106, is condensed by the condensing lens 108, is reflected at the reflection mirror surface 18A of the spinner mirror device 16, and is focused onto the recording medium 14.

As shown in FIG. 1, in this inner drum exposure apparatus 10, the spinner mirror device 16 and the first and second semiconductor laser light sources 30A and 30B are structured so as to be controlled by a central control unit 40 while performing operations for recording an image at the recording medium 14. In the inner drum exposure apparatus 10, when an instruction to input image information that is to be exposed and to commence exposure processing is sent to the central control unit 40 from an unillustrated input device, the central control unit 40 generates predetermined image signals based on the image information that is to be exposed, and sends these predetermined image signals to each of a laser driver 42A for the first semiconductor laser light source 30A and a laser driver 42B for the second semiconductor laser light source 30B.

Correspondingly, the first laser driver 42A and the second laser driver 42B control driving of, respectively, the first and second semiconductor laser light sources 30A and 30B, the laser beams La and Lb are emitted with light amounts modulated on the basis of respective image signals, and are irradiated towards the spinner mirror device 16 by the light source side optical systems.

At the same time, the central control unit 40 controls rotation of the motor 20 and rotates the reflection mirror surface 18A. The laser beams La and Lb which are incident at the reflection mirror surface 18A from the light source side optical systems are reflected thereat and perform scanning exposure onto the recording medium 14, in the main scanning direction. Meanwhile, the central control unit 40 sends control signals to the spinner driver 22. The spinner driver 22, receiving these control signals, controls the unillustrated sub-scanning movement means, and the spinner mirror device 16 moves for scanning at a constant speed in the axial direction of the center axis of the circular arc of the support body 12 (the direction of arrow C, which is a left-right direction, in FIG. 1).

Thus, by the spinner mirror device 16 moving in the sub-scanning direction while the spinner mirror device 16 carries out scanning exposure in the main scanning direction, processing to record an image in two dimensions is carried out over the whole of the recording surface of the recording medium 14.

While the scanning-exposure is being performed, in the inner drum exposure apparatus 10, the circuit serving as the controlling means controls the acoustic optical device 116 and the acoustic optical device 118 which are the light-deflecting means, for deflection. Hence, the laser beam Lb irradiated from the second semiconductor laser light source 30B suitably performs scanning exposure in the main scanning direction in conjunction with operation of the spinner mirror device 16.

Accordingly, as shown in FIG. 15, the control circuit 122 serving as the controlling means supplies the control clock signal based on position signals from the unillustrated encoder provided at the spinner mirror device 16 to the cosine wave signal generation circuit 124. The cosine wave voltage signal outputted from the cosine wave signal generation circuit 124 is converted to a frequency-modulated signal by the voltage-controlled oscillator 128, and then this is supplied to the acoustic optical device 116 via the amplifier 132.

Here, the acoustic optical device 116 deflects the second laser beam Lb in the X-axis direction (a direction of inclination passing through a center of the reflection mirror surface 18A) in accordance with this cosine wave voltage signal (the frequency-modulated signals).

Meanwhile, the control circuit 122 serving as the controlling means supplies the control clock signal to the sine wave signal generation circuit 126. The sine wave voltage signal outputted from the sine wave signal generation circuit 126 is converted to a frequency-modulated signal by the voltage-controlled oscillator 130, and then this is supplied to the acoustic optical device 118 via the amplifier 134.

Here, the acoustic optical device 118 deflects the second laser beam Lb, which has been modulated in the X-axis direction by the acoustic optical device 116, in the Y-axis direction (a direction intersecting the direction of inclination that passes through the center of the reflection mirror surface 18A) in accordance with this sine wave voltage signal.

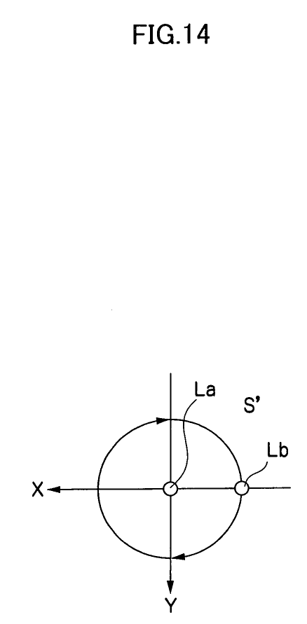

As a result, as shown in FIG. 14, the second laser beam Lb which is directed to the reflection mirror surface 18A of the spinner mirror device 16 describes, synchronously with rotation operations of the spinner mirror device 16, a substantially circular locus in a plane S′ which is orthogonal to the rotating shaft member 18 of the spinner mirror device 16.

Next, actions and operations of the inner drum exposure apparatus relating to the first embodiment, which is structured as described above, will be described.

In this inner drum exposure apparatus 10, the laser beams La and Lb with light amounts modulated in accordance with respective image information are emitted by the first and second semiconductor laser light sources 30A and 30B, which are controlled by the central control unit 40 and, respectively, the first laser driver 42A and the second laser driver 42B.

The second laser beam Lb, which has been emitted from the second semiconductor laser light source 30B (i.e., light beam outputting means), formed into a parallel beam by the collimating lens (collimator lens) 112 and reflected by the reflection mirror 114, is deflected in the X-axis direction by the acoustic optical device 116 which is light-deflecting means, and is deflected in the Y-axis direction by the acoustic optical device 118 which is light-deflecting means.

Further, the deflected second laser beam Lb is condensed by the condensing lens 120, is then reflected at the reflective portion 111 of the sectional optical function member 104, and is guided to the spinner mirror device 16 by the collimating lens 106 and condensing lens 108 of the light source side optical system. The spinner mirror device 16 reflectively deflects the second laser beam Lb with the reflection mirror surface 18A which is rotating about a Z-axis (the axis of rotation) and directs the second laser beam Lb to the recording medium 14.

Meanwhile, the first laser beam La emitted from the first semiconductor laser light source 30A is guided along the Z-axis of the spinner mirror device 16 (the rotation axis), is reflectively deflected by the reflection mirror surface 18A, and is directed to the recording medium 14. Here, the first laser beam La emitted from the first semiconductor laser light source 30A is directed onto the recording medium 14 without movement of a position thereof (a center) in the plane S′ intersecting the rotating shaft member 18.

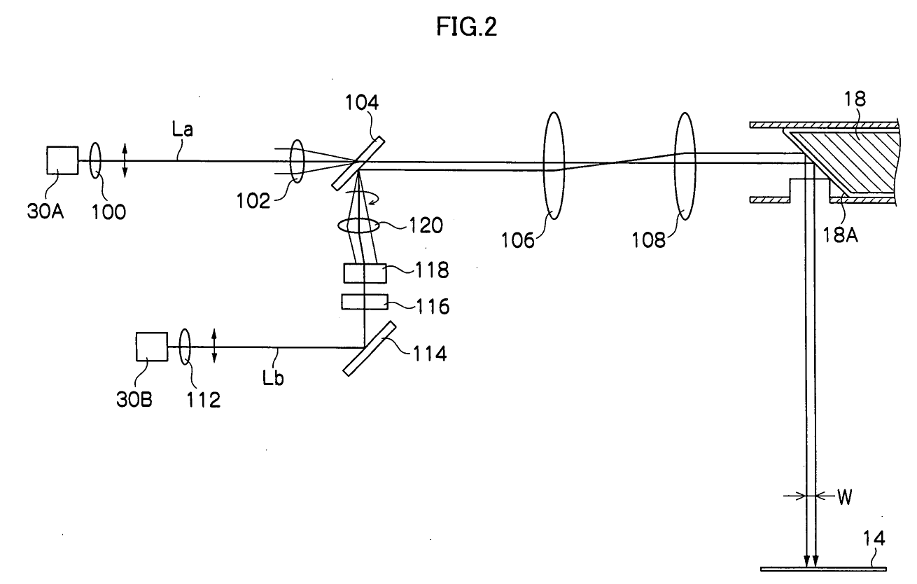

Thus, as shown in FIGS. 1 and 2, the first laser beam La and the second laser beam Lb are controlled to have a certain spacing and are directed at the recording medium 14 to implement recording of an image. Here, the spacing W therebetween can be adjusted with ease by adjustment of amplification rates specified for the amplifier 132 and amplifier 134. Thus, two parallel scanning lines are formed on the recording medium 14 with a certain spacing and a certain length.

Thus, with this inner drum exposure apparatus 10, simultaneous exposure processing with two scanning lines onto the recording medium 14 (i.e., a multibeam structure) is possible. Therefore, it is possible to improve a speed of exposure processing. Furthermore, with this inner drum exposure apparatus 10, it is possible to increase the number of light beams, and it is possible to improve reliability of recording precision according to the scanning by setting a lower rotation speed for the scanning means, without significantly lowering the speed of exposure processing.

In the above-described first embodiment, the acoustic optical device 116 and acoustic optical device 118 which are light-deflecting means are structured as separate bodies. However, it is possible to structure the acoustic optical device 116 and acoustic optical device 118 as a single body, to structure light-deflecting means such that deflection with respect to the X-axis and Y-axis directions is implemented by a single acoustic optical device. Further, instead of employing acoustic optical devices, electro-optical devices may be employed.

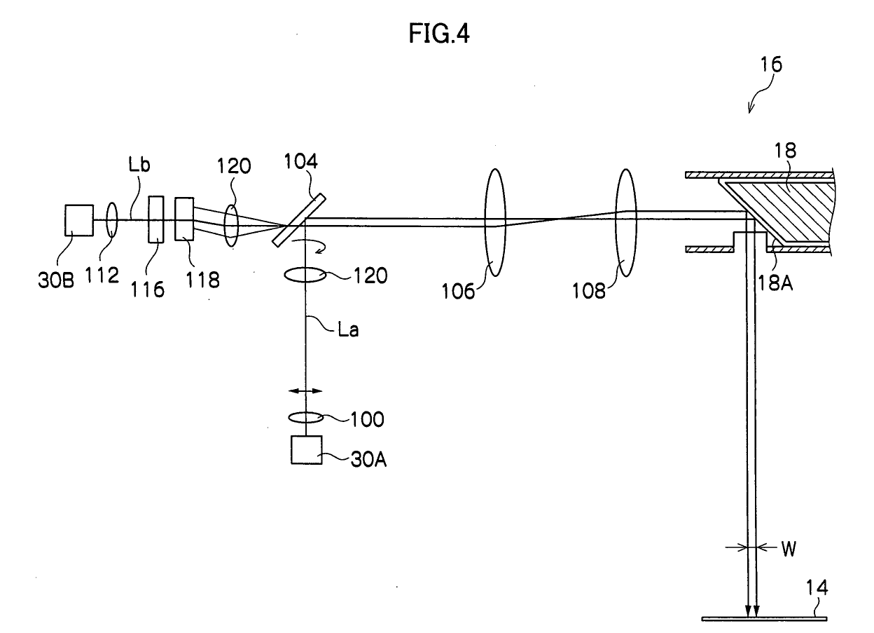

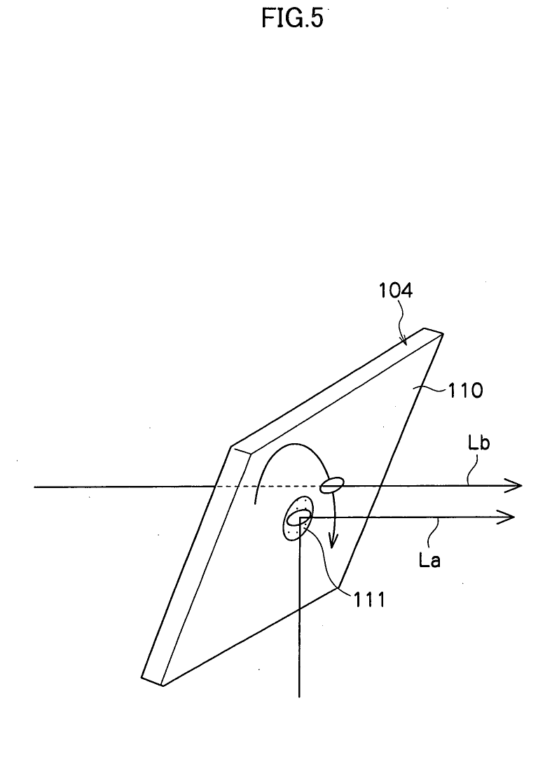

Next, another structural example of the inner drum exposure apparatus relating to this first embodiment, which employs a different structure for the sectional optical function member 104, will be described with FIGS. 4 and 5.

This other structural example shown in FIGS. 4 and 5 is structured such that the laser beam La emitted by the first semiconductor laser light source 30A is condensed by the condensing lens 120 and focused at the reflective portion 111 of the sectional optical function member 104 and hence the laser beam La is reflected by the reflection mirror surface 1 8A of the spinner mirror device 16 and focused onto the recording medium 14. In addition, the laser beam Lb emitted by the second semiconductor laser light source 30B is condensed by the condensing lens 120, transmitted through the transparent portion 110 of the sectional optical function member 104, reflected by the reflection mirror surface 1 8A of the spinner mirror device 16 and focused onto the recording medium 14.

Accordingly, as shown in FIG. 5, at the sectional optical function member 104 that is employed in this other structural example shown in FIGS. 4 and 5, a small elliptical reflection surface (with a shape which is a small ellipse shape in plan view and a circle in a front elevation view of a state which is inclined by a predetermined angle) is formed at a central portion of the sectional optical function member 104 to serve as the reflective portion 111 for reflecting the laser beam La emitted from the first semiconductor laser light source 30A.

Further, the whole surface of the sectional optical function member 104 (or a predetermined range around the reflective portion 111) apart from the reflective portion 111 formed as the small elliptical reflection surface constitutes the transparent portion 110 which transmits the laser beam Lb emitted from the second semiconductor laser light source 30B (or an aperture may be formed).

Here, the sectional optical function member 104 shown in FIG. 5 may be formed overall by a transparent glass plate. In such a case, the reflective portion 111 which is the small elliptical reflection surface at the center is machined to a mirror surface, and other portions may be constituted by the transparent glass.

In the structure shown in FIG. 4, the light path reaching from the second semiconductor laser light source 30B to the sectional optical function member 104 is linearly structured. Therefore, the reflection mirror 114 shown in FIG. 2 is omitted.

Here, except as described above, structures, actions and effects of this other structural example shown in FIGS. 4 and 5 are the same as in the above-described first embodiment. Therefore, descriptions thereof are omitted.

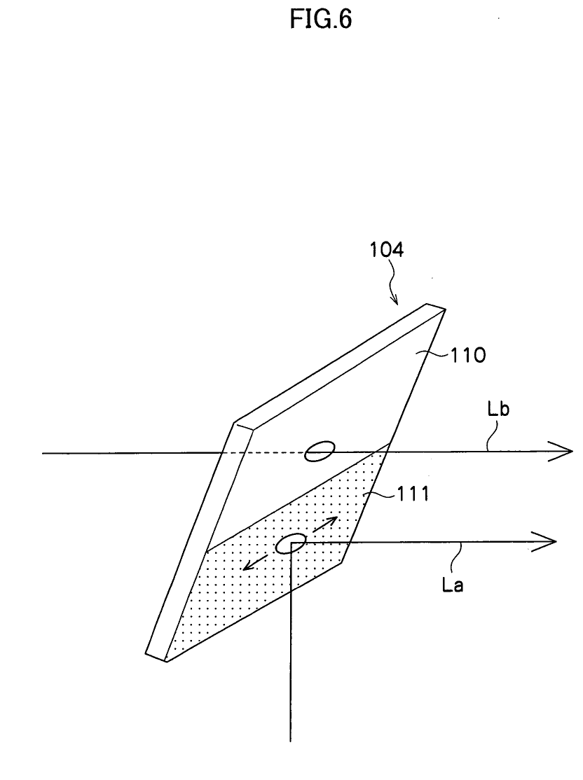

Next, another structural example of the inner drum exposure apparatus relating to this first embodiment, which employs yet another structure for the sectional optical function member 104, will be described with FIG. 6.

In this other structural example shown in FIG. 6, the sectional optical function member 104 is divided in two, an upper side and a lower side, with a linear boundary passing through the middle of the sectional optical function member 104. An upper side section thereof constitutes the transparent portion 110, which transmits the laser beam La irradiated from the first semiconductor laser light source 30A, and a lower side section constitutes the reflective portion 111, which reflects the laser beam Lb irradiated from the second semiconductor laser light source 30B.

Here, the sectional optical function member 104 shown in FIG. 6 may be formed overall by a transparent glass plate, with the reflective portion 111 at the lower side relative to the middle being machined to a mirror surface and the other portion being structured by transparent glass or an aperture. It is also possible to structure the sectional optical function member 104 with the reflective portion 111 alone, structuring so as to specify a region, adjacent to the reflective portion 111, through which the laser beam La irradiated from the first semiconductor laser light source 30A can be transmitted.

With the other structural example shown in FIG. 6, structures at the first and second semiconductor laser light sources 30A and 30B sides are similar to the optical systems shown in FIGS. 1 and 2.

Further, with the other structural example shown in FIG. 6, the optical system of the second semiconductor laser light source 30B side optical system shown in FIGS. 1 and 2 employs the acoustic optical device 116, which is the light-deflecting means for deflecting in the X-axis direction with respect to the spinner mirror device 16. Thus, control is performed to suitably correct a line of deflection of the light beam in relation to angles of rotation of the reflection mirror surface 18A of the spinner mirror device 16, and exposure onto the recording medium 14 is implemented.

That is, with the other structural example shown in FIG. 6, the acoustic optical device deflects along only one axis. Thus, the second semiconductor laser light source 30B side optical system is structured such that the first laser beam La and second laser beam Lb directed to the recording medium 14 are controlled by commonly used correction control means so as to form two parallel straight lines with a certain spacing and a certain length.

For example, the correction control means commences writing at a writing start position of the second laser beam Lb with the commencement delayed by a predetermined duration so as to match a writing start position of the first laser beam La. Then, control is performed so as to finish writing at a writing end position of the second laser beam Lb with the finish advanced by a predetermined duration so as to match a writing end position of the first laser beam La.

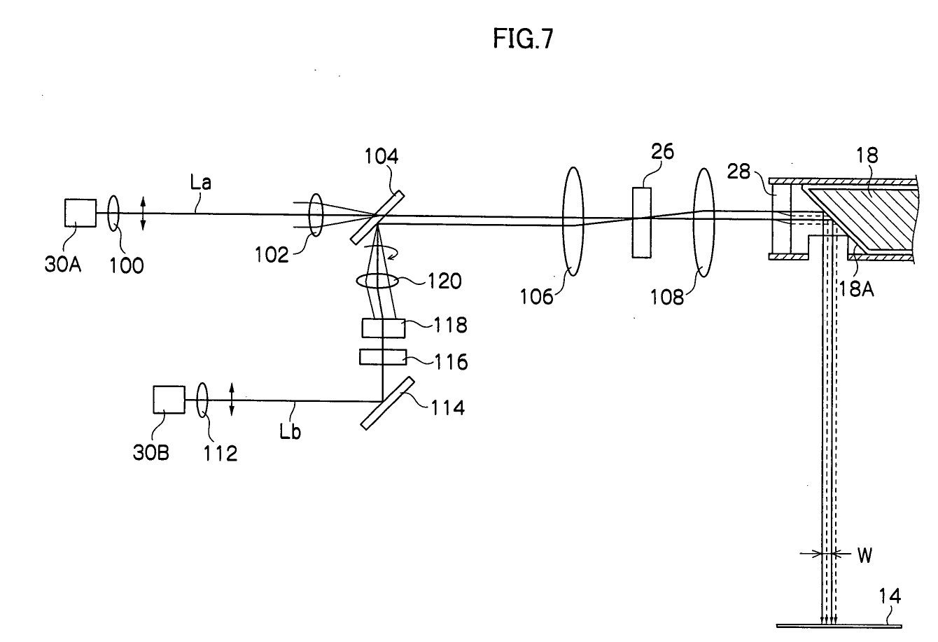

Next, another structural example of the inner drum exposure apparatus relating to this first embodiment, for performing splitting of a beam, and performing main scanning and exposure processing onto the recording surface of the recording medium 14, will be described with FIG. 7.

In the inner drum exposure apparatus 10 shown in FIG. 7, at a position between the collimating lens 106 and the condensing lens 108 of an optical system at the spinner mirror device 16 side relative to the sectional optical function member 104, a quarter-wavelength plate 26 is disposed to act as a polarization control element. Further, a uniaxial crystal optical element 28, which serves as a light beam-splitting element, is disposed so as to rotate integrally with a holder 24, which is fixed at the rotating shaft member 18 of the spinner mirror device 16. This holder 24 is formed in, for example, a cylindrical shape. An aperture for allowing the light beam reflected at the reflection mirror surface 18A to pass through toward the recording medium 14 is formed in the holder 24.

The quarter-wavelength plate 26 is structured so as to convert each of the laser beams La and Lb to circularly polarized light.

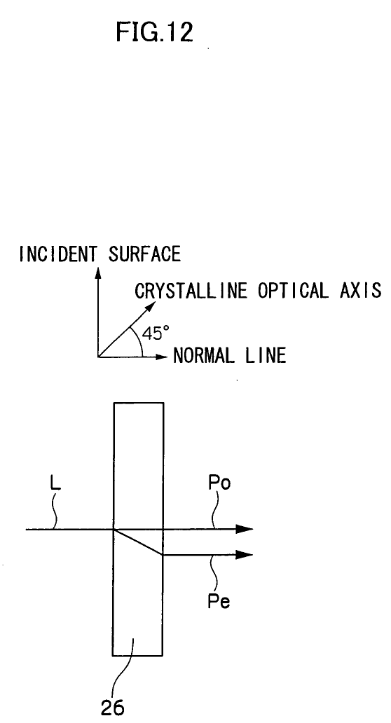

Now, when, for example, a light beam that has been circularly polarized thus is incident at the uniaxial crystal optical element 28, as shown in FIG. 12, the light beam is separated into an ordinary ray Po and an extraordinary ray Pe with equal light amounts, and the ordinary ray Po and extraordinary ray Pe are parallel-shifted with respect to one another. The present embodiment is structured such that this feature of the uniaxial crystal optical element 28 is employed so as to split each of the laser beams La and Lb, in the sub-scanning direction, into respective equal light amounts.

In the inner drum exposure apparatus 10 shown in FIG. 7 which is structured thus, the laser beams La and Lb are emitted from the first and second semiconductor laser light sources 30A and 30B, respectively, pass through the respective optical systems described earlier and are focused onto the sectional optical function member 104. The laser beams La and Lb are similarly focused, with the laser beam Lb circling around the laser beam La.

The laser beams La and Lb which have been emitted in the state described above are respectively circularly polarized by the quarter-wavelength plate 26. Then, the light beams (the first laser beam La and the second laser-beam Lb) that have been circularly polarized as described above are respectively split into equal light amounts in the sub-scanning direction by the uniaxial crystal optical element 28, serving as the splitting element, which is disposed at the optical path downstream side spinner mirror device 16.

In the inner drum exposure apparatus 10 shown in FIG. 7, a light beam focusing spot diameter before the first laser beam La is split into equal light amounts in the sub-scanning direction and a focusing spot diameter of the second laser beam Lb before splitting of the light beam are each made smaller than a recording pixel. Moreover, a separation width of the uniaxial crystal optical element 28 serving as the splitting element is preparatorily set to substantially half of a pixel size.

Thus, shapes of the focusing spots can be set to a state which is close to a rectangular form with respect to the sub-scanning direction, and can be set to well-defined states which are narrowed with respect to the main scanning direction (that is, edge portions of the beam spots are in sharp conditions). Accordingly, it is possible to raise quality of recorded pixels.

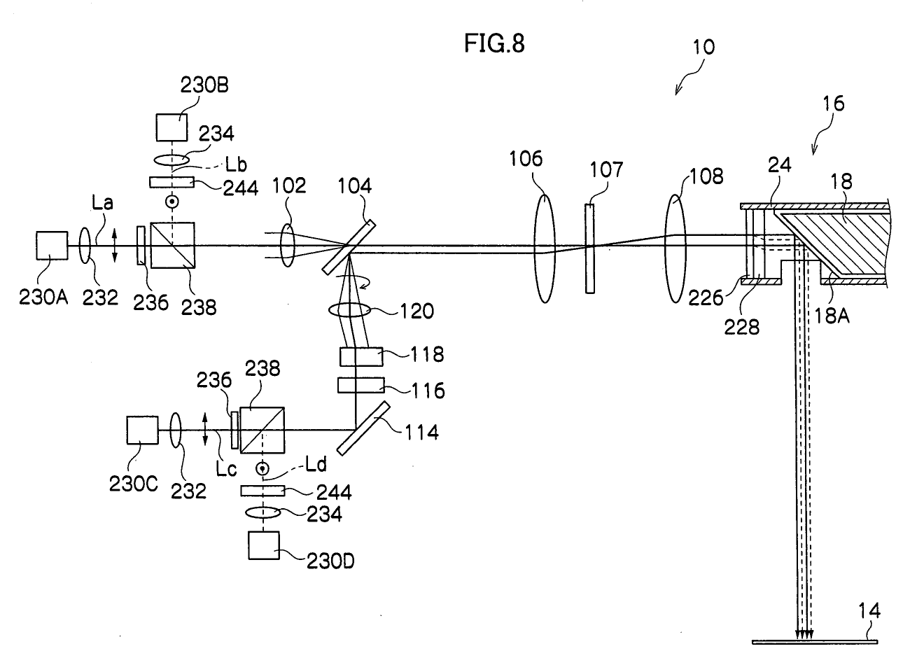

Next, a second embodiment relating to the inner drum exposure apparatus of the present invention will be described with reference to FIGS. 8 to 11. In this second embodiment, the inner drum exposure apparatus 10 is structured so as to carry out beam splitting and perform main scanning onto the recording surface of the recording medium 14 disposed on the inner peripheral face of the support body.

Accordingly, at the spinner mirror device 16 side, a quarter-wavelength plate 226 and a uniaxial crystal optical element 228 are arranged in this order from the optical path upstream side and are fixed to the holder 24, which is fixed so as to rotate integrally with the rotating shaft member 18.

Here, a structure is possible in which the quarter-wavelength plate 226 and the uniaxial crystal optical element 228 are disposed on the optical path forward of the reflection mirror surface 18A of the spinner mirror device 16, and are mounted so as to rotate integrally with the reflection mirror surface 18A by unillustrated, separately provided supporting means.

The quarter-wavelength plate 226 is structured to be capable of converting light beams which have been polarized to right-hand polarized light and left-hand polarized light to linearly polarized light beams which intersect one another.

The uniaxial crystal optical element 228 is structured by a quartz plate which parallel-shifts, of the two linearly polarized light beams that intersect one another, one polarized beam in the sub-scanning direction. This quartz plate is fabricated such that a crystalline optical axis of the quartz is structured with an inclination of 45° with respect to a normal line of a light crystal-incident surface of the quartz.

This quartz plate is easily processed so as to have sufficient accuracy, and can be fabricated at low cost. Furthermore, the quartz that is employed as the material of the uniaxial crystal optical element 228 has the advantages of being materially stable and inexpensive.

Further, for the quartz that is employed as the material of the uniaxial crystal optical element 228, a characteristic of splitting width in relation to inclination angle of the crystalline optical axis is known. Thus, it is possible to structure the uniaxial crystal optical element 228 to feature required characteristics in accordance with characteristics of this quartz.

Herein, this uniaxial crystal optical element 228 may be structured with a uniaxial crystal other than quartz as the material thereof. When the uniaxial crystal optical element 228 is structured by a uniaxial crystal other than quartz, for a crystalline optical axis of 45°, a machining error of the inclination angle is of the order of ±1°, and it is possible to suppress an error in separation width.

This uniaxial crystal optical element 228 may be structured using, for example, a uniaxial material such as calcite, lithium niobate or the like. Here, if calcite is used, thickness can be reduced. Consequently, weight can be kept down, and there is an advantage in that it is possible to reduce limitations on rotation speed of the spinner mirror device 16. In such a case, it is desirable if the quarter-wavelength plate 226 and the uniaxial crystal optical element 228 made of calcite are adhered for use.

As shown in FIG. 8, in order to perform beam splitting and main scanning onto the recording surface of the recording medium 14, this inner drum exposure apparatus 10 is provided with light source side optical systems which project light beams for making the light beams incident at the spinner mirror device 16.

In this inner drum exposure apparatus 10, four semiconductor laser light sources (light beam-outputting means)—first, second, third and fourth semiconductor laser light sources 230A, 230B, 230C and 230D—are employed. In addition, separate sets of optical systems are structured for the pair of first and second semiconductor laser light sources 230A and 230B and for the pair of third and fourth semiconductor laser light sources 230C and 230D.

The set of first and second semiconductor laser light sources 230A and 230B emit respective linearly polarized light beams (laser beams) La and Lb. In the optical systems of this set, both of these laser beams La and Lb are formed as parallel beams by respective collimating lenses (collimator lenses) 232 and 234.

The first laser beam La emitted from the first semiconductor laser light source 230A is specified so as to be p-polarized light with respect to a reflection surface of a polarizing beam splitter 238. After transmission through a parallel flat plate 236, the first laser beam La is transmitted through the polarizing beam splitter 238 and proceeds along an optical path.

Meanwhile, a polarization direction of the second laser beam Lb is turned through 90° to be s-polarized light, by transmission through a half-wavelength plate 244, after which the second laser beam Lb is incident at the polarizing beam splitter 238. Hence, the second laser beam Lb, being s-polarized light, is reflected by the reflection surface of the polarizing beam splitter 238, is multiplexed as coaxial polarized light with the first laser beam La, and proceeds along the same optical path.

The first laser beam La and second laser beam Lb emitted from the polarizing beam splitter 238, which have been polarized and coaxially multiplexed as described above, pass along an optical path structured by the condensing lens 102, the sectional optical function member 104, the collimating lens 106, a quarter-wavelength plate 107 and the condensing lens 108, which are arranged in this order, and the first and second laser beams La and Lb enter into the spinner mirror device 16.

Meanwhile, the set of third and fourth semiconductor laser light sources 230C and 230D emit respective linearly polarized light beams (laser beams) Lc and Ld. In the optical systems of this set, both of these light beams Lc and Ld are formed as parallel beams by respective other collimating lenses (collimator lenses) 232 and 234.

The third laser beam Lc emitted from the third semiconductor laser light source 230C is specified so as to be p-polarized light with respect to a reflection surface of another polarizing beam splitter 238 and, after transmission through another parallel flat plate 236, is transmitted through the polarizing beam splitter 238 and proceeds along an optical path.

Meanwhile, a polarization direction of the fourth laser beam Ld is turned through 90° to be s-polarized light, by transmission through another half-wavelength plate 244, after which the fourth laser beam Ld is incident at the polarizing beam splitter 238. Hence, the fourth laser beam Ld, being s-polarized light, is reflected by the reflection surface of the polarizing beam splitter 238, is multiplexed as coaxial polarized light with the third laser beam Lc, and proceeds along the same optical path.

The third laser beam Lc and fourth laser beam Ld emitted from the polarizing beam splitter 238, which have been polarized and coaxially multiplexed as described above, pass along an optical path structured by the reflection mirror 114, the acoustic optical device 116 which is the light-deflecting means for deflection in the X-axis direction with respect to the spinner mirror device 16, the acoustic optical device 118 which is the light-deflecting means for deflection in the Y-axis direction, the condensing lens 120, and the shared sectional optical function member 104, collimating lens 106, quarter-wavelength plate 107 and condensing lens 108, which are arranged in this order, and the third and fourth laser beams Lc and Ld enter into the spinner mirror device 16.

Herein, the condensing lens 102, the sectional optical function member 104, the reflection mirror 114, the acoustic optical device 116, the acoustic optical device 118, the condensing lens 120, the collimating lens 106 and the condensing lens 108 which are employed in this inner drum exposure apparatus 10 relating to the second embodiment are respectively provided with the same structures, actions and effects as described for the inner drum exposure apparatus 10 relating to the first embodiment described earlier.

Further, in the optical system of this second embodiment, in order to put at least beams entering the collimating lens 106, which is closest to the spinner mirror device 16, into circularly polarized states, a quarter-wavelength plate, which is not illustrated, is disposed at a required position on the optical paths reaching from the light sources to the collimating lens 106.

Next, actions and operations of the inner drum exposure apparatus 10 relating to the second embodiment, which is structured as described above, will be described.

In the inner drum exposure apparatus 10 relating to this second embodiment, the first laser beam La with light amounts modulated in accordance with image information is outputted by the semiconductor laser light source 230A, which is controlled by the central control unit and a laser driver. The first laser beam La is formed as a parallel beam by the collimating lens (collimator lens) 232 and transmitted through the parallel flat plate 236, and is then incident at the polarizing beam splitter 238. Here, because the first laser beam La is formed as p-polarized light with respect to the reflection surface of the polarizing beam splitter 238, the first laser beam La passes through the polarizing beam splitter 238 and proceeds.

Meanwhile, the second laser beam Lb from the semiconductor laser light source 230B, with light amounts modulated in accordance with image information, is formed as a parallel beam by the collimating lens (collimator lens) 234 and a polarization direction thereof is turned through 90° to make s-polarized light, by transmission through the half-wavelength plate 244. The second laser beam Lb is then incident at the polarizing beam splitter 238.

Then, the second laser beam Lb, being s-polarized light, is reflected by the reflection surface of the polarizing beam splitter 238, is multiplexed as coaxial polarized light with the first laser beam La, and passes along the optical path through the condensing lens 102, the transparent portion 110 of the sectional optical function member 104, and the collimating lens 106, and is transmitted through the quarter-wavelength plate 107.

When the first laser beam La and second laser beam Lb which are multiplexed as coaxial polarized light pass through the quarter-wavelength plate 107, the first laser beam La and the second laser beam Lb are converted to right-hand circularly polarized light and left-hand circularly polarized light, respectively. Then, the laser beams La and Lb which have been circularly polarized in this manner pass through the condensing lens 108, which is for composing focusing points on the recording surface, and are directed to the spinner mirror device 16 of the scanning optical system, which is equipped with the quarter-wavelength plate 226 and the uniaxial crystal optical element 228.

The first laser beam La and second laser beam Lb, which have previously been converted to right-hand polarized light and left-hand polarized light, are converted to light beams with mutually intersecting linear polarizations while passing through the quarter-wavelength plate 226 of the scanning optical system, and enter the uniaxial crystal optical element 228. Thus, of these two light beams which are linearly polarized perpendicularly to one another, one polarized light beam is separated off so as to be parallel-shifted in the sub-scanning direction.

Thereafter, the above-described linearly polarized light beams are directed along the rotation axis of the spinner mirror device 16, are reflectively deflected by the reflection mirror surface 18A, and are directed to the recording medium 14.

Concurrently therewith, in this inner drum exposure apparatus 10, firstly, the third laser beam Lc is modulated in accordance with image information and outputted by the semiconductor laser light source 230C, which is controlled by the central control unit and a laser driver. The outputted third laser beam Lc is formed as a parallel beam by the collimating lens (collimator lens) 232 and transmitted through the parallel flat plate 236, and is thereafter incident at the polarizing beam splitter 238.

Here, because the third laser beam Lc is formed as p-polarized light with respect to the reflection surface of the polarizing beam splitter 238, the third laser beam Lc passes through the polarizing beam splitter 238 and proceeds.

Meanwhile, the fourth laser beam Ld, which is modulated in accordance with image information and outputted by the semiconductor laser light source 230D, is formed as a parallel beam by the collimating lens (collimator lens) 234. A polarization direction of this fourth laser beam in the form of a parallel beam is turned through 90° to make s-polarized light by transmission through the half-wavelength plate 244. Thereafter, the fourth laser beam Ld is incident at the polarizing beam splitter 238.

Thus, the fourth laser beam Ld, being s-polarized light, is reflected by the reflection surface of the polarizing beam splitter 238, is multiplexed as coaxial polarized light with the third laser beam Lc, and proceeds along the optical path.

Hence, the third laser beam Lc and fourth laser beam Ld which have been multiplexed as coaxial polarized light are reflected at the reflection mirror 114 on the optical path, are deflected in the X-axis direction by the acoustic optical device 116 which is light-deflecting means, and are deflected in the Y-axis direction by the acoustic optical device 118 which is light-deflecting means.

Then, the third laser beam Lc and fourth laser beam Ld which have been polarized and coaxially multiplexed are condensed by the condensing lens 120 and then reflected at the reflective portion 111 of the sectional optical function member 104, pass through the collimating lens 106 of the light source side optical system, and are transmitted through the quarter-wavelength plate 107.

When the third laser beam Lc and fourth laser beam Ld, which have been polarized and coaxially multiplexed as described above pass through the quarter-wavelength plate 107, the third laser beam Lc and the fourth laser beam Ld are converted to right-hand polarized light and left-hand polarized light, respectively. Then, the laser beams Lc and Ld which have been circularly polarized pass through the condensing lens 108, which is for composing focusing points on the recording surface, and are directed to the spinner mirror device 16 of the scanning optical system, which is equipped with the quarter-wavelength plate 226 and the uniaxial crystal optical element 228.

Here, the third laser beam Lc and fourth laser beam Ld, which have been converted to right-hand polarized light and left-hand polarized light, are converted to light beams with mutually intersecting linear polarizations while passing through the quarter-wavelength plate 226 of the scanning optical system, and enter the uniaxial crystal optical element 228.

Of these two light beams which are linearly polarized perpendicularly to one another, one polarized light beam is separated so as to be parallel-shifted in the sub-scanning direction. Thereafter, the above-described linearly polarized light beams are directed along a straight line at a predetermined distance of spacing from the rotation axis of the spinner mirror device 16, are reflectively deflected by the reflection mirror surface 18A, and are directed to the recording medium 14.

Thus, according to this inner drum exposure apparatus 10, the first, second, third and fourth laser beams La, Lb, Lc and Ld are respectively modulated and emitted from the quartet of first, second, third and fourth semiconductor laser light sources 230A, 230B, 230C and 230D, and are simultaneously irradiated onto the recording medium 14 for simultaneous exposure. Consequently, it is possible to implement efficient, rapid exposure processing.

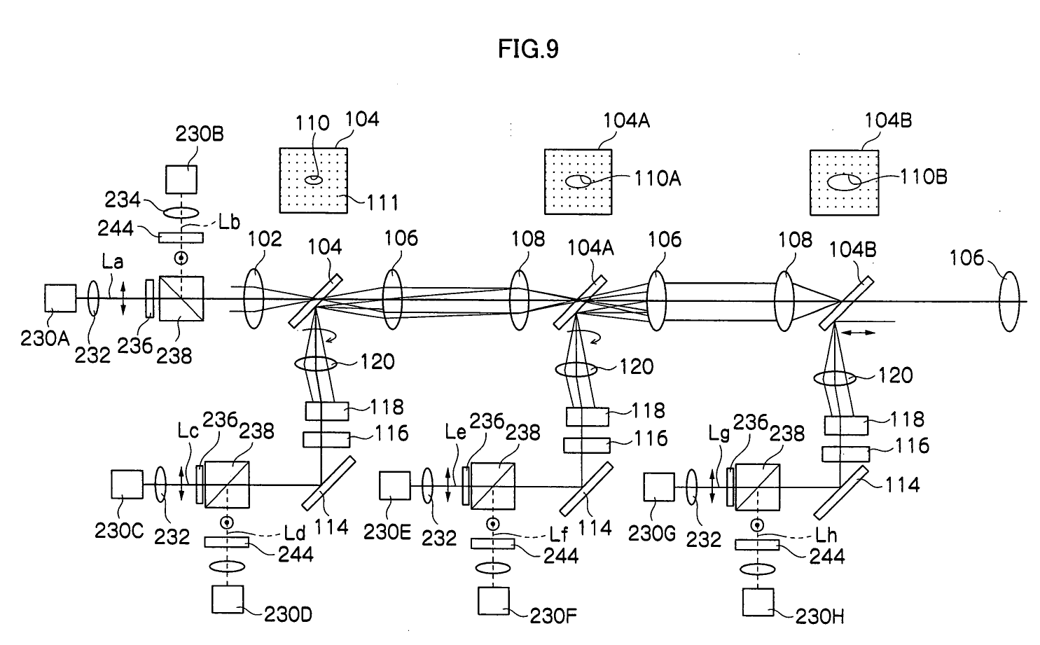

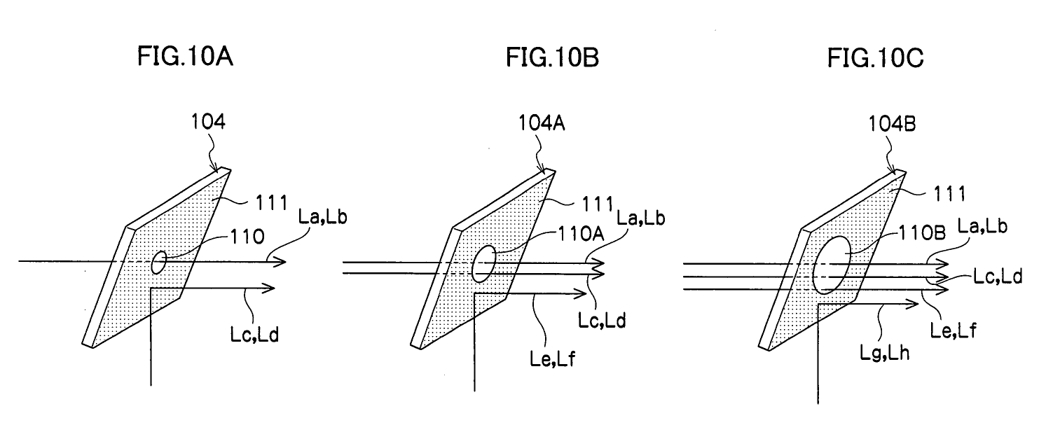

Next, another structural example of the inner drum exposure apparatus 10 relating to this second embodiment will be described with FIGS. 9 and 10A to 10C. In this other structural example shown in FIGS. 9 and 10A to 10C, the sectional optical function member 104 is provided at a number of stages. Accordingly, it is possible to specify a plurality of optical paths for simultaneous entry of a plurality of light beams, which are parallel with small spacings therebetween, into the spinner mirror device 16.

In this other structural example shown in FIGS. 9 and 10A to 10C, three sectional optical function members 104, 104A and 104B are arranged in a row on a set of optical paths. In this other structural example, a portion corresponding to the sectional optical function member 104, which is at an upstreammost side of the optical paths, is structured similarly to the portion shown in the above-described FIG. 8, which reaches from the quartet of first, second, third and fourth semiconductor laser light sources 230A, 230B, 230C and 230D to the sectional optical function member 104.

Further, in this other structural example shown in FIGS. 9 and 10A to 10C, another collimating lens 106 and another condensing lens 108 are disposed between the sectional optical function member 104 and the collimating lens 106 of FIG. 8. The sectional optical function member 104A is also disposed between the sectional optical function member 104 and the collimating lens 106 of FIG. 8, at a position at which light beams that have passed through this other collimating lens 106 and other condensing lens 108 are condensed and focused.

As shown in FIGS. 10A to 10C, the sectional optical function member 104A is formed with size of a transparent portion 110A thereof being a size sufficient for transmitting the four laser beams La, Lb, Lc and Ld (which have been multiplexed into two light beams) in the state in which these four laser beams have been condensed by the another condensing lens 108.

In FIG. 9, it is illustrated that the transparent portion 110 and transparent portion 110A and a transparent portion 110B, which are formed at the sectional optical function members 104, 104A and 104B, are elliptical. This is because the transparent portions 110, 110A and 110B are formed so as to be circular when viewed in front elevations when the respective sectional optical function members 104, 104A and 104B are inclined at inclination angles of 45°. That is, the transparent portions 110, 110A and 110B are formed in predetermined elliptical shapes in respective plan views thereof.

As shown in FIG. 9, optical path portions reaching from a pair of fifth and sixth semiconductor laser light sources 230E and 230F to the sectional optical function member 104A are structured similarly to the above-described portions reaching from the third and fourth semiconductor laser light sources 230C and 230D to the sectional optical function member 104.

Further, in this other structural example, yet another of the collimating lens 106 and yet another of the condensing lens 108 are disposed at a downstream side of the sectional optical function member 104A, and the sectional optical function member 104B is disposed at a position at which light beams that have passed through this yet another collimating lens 106 and yet another condensing lens 108 are condensed and focused.

As shown in FIGS. 10A to 10C, the sectional optical function member 104B is formed with size of the transparent portion 110B thereof being a size sufficient for transmitting the six laser beams La, Lb, Lc, Ld, Le and Lf (which are multiplexed into three light beams) in the state in which these six laser beams have been condensed by the yet another condensing lens 108.

As shown in FIG. 9, optical path portions reaching from a pair of seventh and eighth semiconductor laser light sources 230G and 230H to the sectional optical function member 104B are structured similarly to the above-described portions reaching from the third and fourth semiconductor laser light sources 230C and 230D to the sectional optical function member 104.

In this other structural example shown in FIGS. 10A to 10C which is structured as described above, the laser beams La and Lb are emitted from the first and second semiconductor laser light sources 230A and 230B and multiplexed, and are condensed by the condensing lens 102. These emitted, multiplexed and condensed laser beams La and Lb are transmitted through the transparent portion 110 of the sectional optical function member 104.

Circling around these multiplexed laser beams La and Lb, the laser beams Lc and Ld, which are emitted from the semiconductor laser light sources 230C and 230D, multiplexed and condensed by the condensing lens 120, are focused onto the reflective portion 111 of the sectional optical function member 104, and focused images thereof are reflected in a concentrically circling state.

Then, at the sectional optical function member 104A, the laser beams La, Lb, Lc and Ld, which have been condensed by the another condensing lens 108, pass through the transparent portion 110A, and the laser beams Le and Lf, which have been condensed by the condensing lens 120, are reflected at the reflective portion 111A of the sectional optical function member 104A. Hence, focused images of the multiplexed laser beams Le and Lf on the reflective portion 111A are in a concentrically circling state at an outer side relative to focused images of the circling laser beams Lc and Ld.

Then, at the sectional optical function member 104B, the laser beams La, Lb, Lc, Ld, Le and Lf, which have been condensed by the yet another condensing lens 108, pass through the transparent portion 110B, and the laser beams Lg and Lh, which have been condensed by the condensing lens 120, are reflected at the reflective portion 111B of the sectional optical function member 104B. Hence, focused images on the reflective portion 111B of the laser beams Lg and Lh, which have been multiplexed and condensed by the condensing lens 120, are in a concentrically circling state at an outer side relative to focused images of the circling laser beams Le and Lf.

In the state which is focused thus, the multiplexed laser beams La and Lb serve as a center, the multiplexed laser beams Lc and Ld concentrically circle therearound, the multiplexed laser beams Le and Lf concentrically circle at the outer side of the multiplexed laser beams Lc and Ld, and the multiplexed laser beams Lg and Lh concentrically circle at the further outer side of the multiplexed laser beams Le and Lf.

Although not illustrated, these multiplexed laser beams La, Lb, Lc, Ld, Le, Lf, Lg and Lh pass through the quarter-wavelength plate 107, the condensing lens 108, the quarter-wavelength plate 226 and the uniaxial crystal optical element 228, which are structured in a similar manner as in the earlier-described inner drum exposure apparatus 10 of FIG. 8, and these laser beams are reflected at the reflection mirror surface 18A and are directed onto the recording medium 14.

At this time, the respective multiplexed multiplex laser beams (La and Lb), (Lc and Ld), (Le and Lf) and (Lg and Lh) are respectively separated in the same manner as in the earlier-described inner drum exposure apparatus 10 of FIG. 8 and directed to the recording medium 14.

Thus, in this other structural example shown in FIGS. 9 and 10A to 10C, the first to eighth laser beams La to Lh, which are respectively modulated and emitted from the octet of first, second, third, fourth, fifth, sixth, seventh and eighth semiconductor laser light sources 230A, 230B, 230C, 230D, 230E, 230F, 230G and 230H, are simultaneously irradiated onto the recording medium 14 to expose the same. Therefore, it is possible to perform exposure processing efficiently and rapidly.

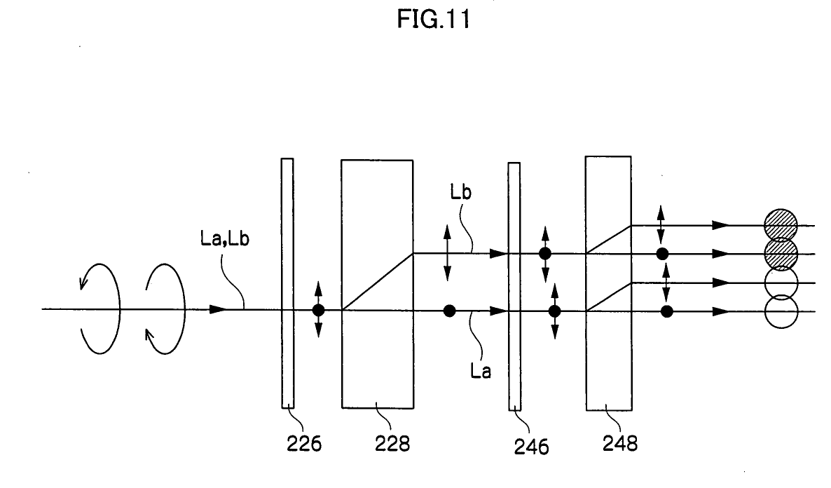

Next, another structural example of the inner drum exposure apparatus 10 relating to this second embodiment, for implementing beam splitting, main-scanning onto the recording surface of the recording medium 14 and performing exposure processing, will be described with FIG. 11.

In this inner drum exposure apparatus 10 shown in FIG. 11, in succession with the quarter-wavelength plate 226 and the uniaxial crystal optical element 228, a half-wavelength plate 246, which is a polarization control element, and a uniaxial crystalline optical element 248, which serves as a light beam-splitting element, are disposed at the holder 24 which is fixed to the rotating shaft member 18 of the spinner mirror device 16.

Although this is not illustrated, the quarter-wavelength plate 226, the uniaxial crystal optical element 228, the quarter-wavelength plate 246 and the uniaxial crystalline optical element 248 are structured so as to rotate integrally with the reflection mirror surface 18A.

At the inner drum exposure apparatus 10 which is structured thus, when, for example, the first laser beam La and the second laser beam Lb, which have been converted to coaxially multiplexed right-hand polarized light and left-hand polarized light, respectively, by the light source side optical system thereof, pass through the quarter-wavelength plate 226, the first laser beam La and second laser beam Lb are converted to linearly polarized light beams which intersect one another. When these mutually intersecting linearly polarized light beams pass through the uniaxial crystal optical element 228, the first laser beam La and the second laser beam Lb are respectively split apart in the sub-scanning direction.

Then, when the first laser beam La and second laser beam Lb which have been split in the sub-scanning direction pass through the quarter-wavelength plate 246 which serves as a polarization control element, polarization angles of the light beams are turned by 45°. Then, when the first laser beam La and the second laser beam Lb pass through the second uniaxial crystalline optical element 248 which serves as a splitting element, the first laser beam La is split into substantially equal light amounts in the sub-scanning direction, and the second laser beam Lb is split into substantially equal light amounts in the sub-scanning direction. That is, in this inner drum exposure apparatus 10, the first laser beam La and the second laser beam Lb are split apart in the sub-scanning direction by the first quarter-wavelength plate 226 and the first uniaxial crystal optical element 228 disposed at the upstream side of the reflection mirror surface 18A.

Then the first laser beam La and second laser beam Lb, which have been split in the sub-scanning direction, are respectively circularly polarized by the second quarter-wavelength plate 246, which is an polarization control element disposed at the downstream side relative to the first uniaxial crystal optical element 228. Thus, a structure is possible such that the circularly polarized first laser beam La and second laser-beam Lb are respectively split into equal light amounts in the sub-scanning direction at the second uniaxial crystalline optical element 248.

Here, obviously, the multiplexed laser beams (Lc and Ld), (Le and Lf) and (Lg and Lh) are also split into substantially equal light amounts in the sub-scanning direction in the same manner as for the multiplexed laser beam (La and Lb) as described above.

In the inner drum exposure apparatus 10 which is structured thus, a light beam focusing spot diameter of each laser beam before being split into equal light amounts in the sub-scanning direction is made smaller than a respective recording pixel, and a separation width of the second uniaxial crystalline optical element 248 serving as the splitting element is preparatorily set to substantially half of a pixel size. Thus, a state which is closer to a rectangular form with respect to the sub-scanning direction is possible, and spot shapes with well-defined states which are narrowed with respect to the main scanning direction are possible (that is, edge portions of beam spots are in sharp conditions). As a result, it is possible to raise quality of recorded pixels.

Here, except as described above, structures, actions and effects of this second embodiment are the same as in the earlier-described first embodiment. Therefore, descriptions thereof are omitted.

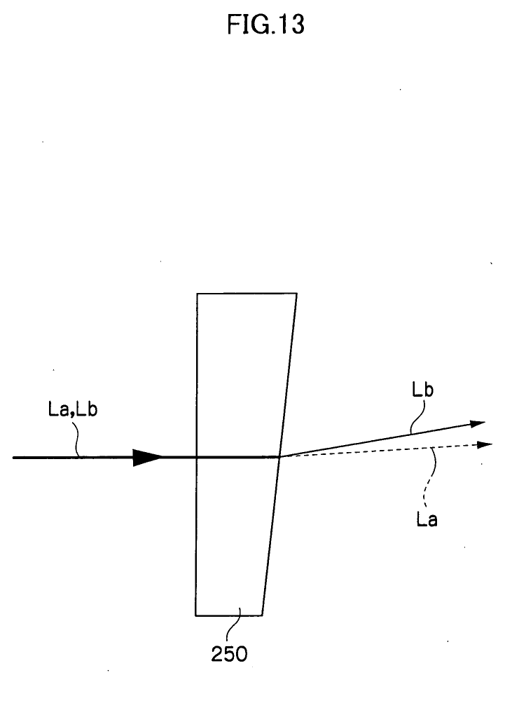

For the first and second embodiments described hereabove, structures in which a light beam-splitting element is formed by a uniaxial crystal optical element and beam splitting is performed such that an incident light beam has equal light amounts in an ordinary ray and an extraordinary ray, which are then parallel-shifted with respect to one another, have been described. However, in an inner drum exposure apparatus of the present invention, it is also possible to employ, for example, a single light beam-splitting element 250 which is a prismic quartz plate, as shown in FIG. 13.

That is, a structure is possible in which, at one face, phase velocities of the fast axis and the slow axis are the same, while at the other face, phase velocities are such that one of the fast axis and the slow axis is inclined relative to the other, and as a result, incident laser beams La and Lb are respectively split apart in the direction in which the angles differ (i.e., “angular splitting”).

What is claimed is:

1. An inner drum-type multibeam exposure method comprising the steps of:
controlling deflection, with light-deflecting means, of at least one of a plurality of light beams, which light beams are respectively independently modulated in accordance with image signals and emitted from a light source side;
condensing the deflection-controlled light beam and another of the light beams at a respective reflection portion and transmission portion, which are provided at different positions of a sectional optical function member, and, with the sectional optical function member, reflecting at least one of the light beams at the reflection portion and transmitting each other of the light beams through the transmission portion for specifying an optical path of the another light beam and an optical path of the deflection-controlled light beam so as to be incident at scanning means; and
scanning for exposure on a recording medium which is disposed at a support body of an inner drum, while the scanning means maintains a predetermined spacing between the plurality of light beams in a sub-scanning direction.

2. An inner drum-type multibeam exposure method comprising the steps of:
(a) controlling deflection, with light-deflecting means, of at least one of a plurality of light beams, which light beams are respectively independently modulated in accordance with image signals and emitted from a light source side;
(b) causing the deflection-controlled light beam to be incident at scanning means via one of a reflection portion and a transmission portion which are provided at a sectional optical function member, and causing another of the light beams, which is not deflection-controlled by the light-deflecting means, to be incident at the scanning means via the other of the reflection portion and the transmission portion; and
(c) with the scanning means, scanning for exposure on a recording medium, which is disposed at a support body of an inner drum, while a sub-scanning direction spacing between the plurality of light beams is maintained at a predetermined distance.

3. The inner drum-type multibeam exposure method of claim 2, further comprising the steps of: passing the light beams that have been emitted from the sectional optical function member through a quarter-wavelength plate for converting the light beams to circularly polarized light; separating the circularly polarized light beams with a uniaxial crystal disposed at the scanning means side of the quarter-wavelength plate; and focusing the light beams on the recording medium in a state in which the predetermined spacing in the sub-scanning direction is opened therebetween.

4. The inner drum-type multibeam exposure method of claim 2, wherein step (a) includes the step of (c) controlling polarization, with light-polarizing means, of a light beam which is obtained by polarizing and multiplexing two of the light beams with a polarizing beam splitter, and
step (b) includes the step of (d) employing the light beam which is obtained by polarizing and multiplexing the two light beams with the polarizing beam splitter as the another light beam which is not deflection-controlled by the light-deflecting means.

5. The inner drum-type multibeam exposure method of claim 2, further comprising the steps of: passing the light beams that have been emitted from the sectional optical function member through a quarter-wavelength plate for converting the light beams to circularly polarized light; converting the circularly polarized light beams to light beams with mutually intersecting linear polarizations with another quarter-wavelength plate; thereafter, separating the light beams with a uniaxial crystal; and focusing the light beams on the recording medium in a state in which the predetermined spacing in the sub-scanning direction is opened therebetween.

6. The inner drum-type multibeam exposure method of claim 4, further comprising the steps of: performing the polarization control of step (c) with another two light beams to obtain a light beam; causing the obtained light beam to be incident at the scanning means via one of a reflection portion and a transmission portion which are provided at another sectional optical function member, which is disposed downstream of the sectional optical function member; and causing the light beams emitted from the sectional optical function member to be incident at the scanning means via the other of the reflection portion and the transmission portion of the other sectional optical function member.

7. An inner drum exposure apparatus comprising:
a plurality of optical systems at a light source side, for emitting light beams which are modulated in accordance with image signals;
light-deflecting means disposed on an optical path of at least one of the plurality of light source side optical systems so as to control deflection of a light beam;
a condensing lens which condenses the light beam that has been deflection-controlled by the light-deflecting means;
a condensing lens which condenses a light beam emitted from the plurality of light source side optical systems other than the deflection-controlled light beam;
a sectional optical function member, which is disposed such that a focusing position of the light beam that has been deflection-controlled by the light-polarizing means and a focusing position of the light beam emitted from the plurality of light source side optical systems which is not the deflection-controlled light beam correspond with a reflection portion and a transmission portion which are provided at different positions of the sectional optical function member, the sectional optical function member reflecting at least one of the light beams at the reflection portion and transmitting each other of the light beams through the transmission portion, for specifying an optical path of the light beam emitted from the plurality of light source side optical systems which is not the deflection-controlled light beam and an optical path of the deflection-controlled light beam so as to be incident at scanning means; and
the scanning means, which, while maintaining a predetermined spacing in a sub-scanning direction between the plurality of light beams that have passed along optical paths specified by the sectional optical function member and are incident at the scanning means, focuses the plurality of light beams onto a recording medium disposed at a support body of an inner drum and performs scanning for exposure.

8. The inner drum exposure apparatus of claim 7, further comprising at least one combination of a plurality of types of optical member, the combination of optical members including:
a condensing lens which condenses the plurality of light beams that have passed along the optical paths specified by the sectional optical function member;
light-deflecting means for controlling deflection of either a light beam from one of the light sources, which has been modulated in accordance with the image signals, or light beams from two of the light sources, which have been respectively modulated in accordance with the image signals and have been polarized and coaxially multiplexed;
a condensing lens which condenses the light beam that has been deflection-controlled by the light-deflecting means; and
another sectional optical function member, which is disposed such that a focusing position of the plurality of light beams that have passed along the optical paths specified by the sectional optical function member and a focusing position of the light beam that has been deflection-controlled by the light-deflecting means correspond with a reflection portion and a transmission portion which are provided at different positions of the other sectional optical function member, the other sectional optical function member reflecting at least one light beam at the reflection portion and transmitting each other of the light beams through the transmission portion, for specifying an optical path of the plurality of light beams that have passed along the optical paths specified by the sectional optical function member and an optical path of the light beam that has been deflection-controlled by the light-deflecting means,
wherein the combination of optical members is disposed on an optical path at an upstream side relative to the scanning means, for specifying multibeam in multiple stages.

9. The inner drum exposure apparatus of claim 7, wherein the sectional optical function member is formed with the transmission portion in an elliptical shape in plan view and the reflection portion being formed around the transmission portion, the transmission portion transmitting the light beam in a condensed state, and the reflection portion reflecting the light beam that has been deflection-controlled by the light-deflecting means in a condensed state.

10. The inner drum exposure apparatus of claim 7, wherein the sectional optical function member is formed with the reflection portion in an elliptical shape in plan view and the transmission portion being formed around the reflection portion, the reflection portion reflecting the light beam in a condensed state, and the transmission portion transmitting the light beam that has been deflection-controlled by the light-deflecting means in a condensed state.

11. The inner drum exposure apparatus of claim 7, wherein the sectional optical function member is divided in two with a linear boundary, one section thereof structuring the transmission portion for transmitting the light beam condensed thereat, and the other section thereof structuring the reflection portion for reflecting the light beam condensed thereat.

12. The inner drum exposure apparatus of claim 7, wherein
at least two of the light beams of the plurality of light source side optical systems are polarized and multiplexed by a polarizing beam splitter and are then transmitted through a quarter-wavelength plate to be circularly polarized,
the light beams which have been polarized and multiplexed and converted to circularly polarized light are converted to light beams with mutually intersecting linear polarizations by another quarter-wavelength plate,
the light beams with mutually intersecting linear polarizations are separated by a uniaxial crystal which is disposed at the scanning means side, and
the light beams are focused on the recording medium with the predetermined spacing in the sub-scanning direction opened therebetween.

13. The inner drum exposure apparatus of claim 12, wherein a polarization control element and a splitting element are disposed at an optical path downstream side relative to the uniaxial crystal, the polarization control element controlling a polarization direction of each light beam, and the splitting element splitting the each light beam which has passed through the polarization control element in the sub-scanning direction, the each light beam being split into substantially equal light amounts in the sub-scanning direction.

14. An inner drum exposure apparatus comprising:
a plurality of optical systems at a light source side, for emitting light beams which are modulated in accordance with image signals;
light-deflecting means disposed at the plurality of light source side optical systems so as to control deflection of the light beam of at least one of the optical systems;
a condensing lens which condenses the light beam that has been deflection-controlled by the light-deflecting means;
a condensing lens which condenses a light beam that has not been deflection-controlled by the light-deflecting means;
scanning means for performing scanning for exposure; and
a sectional optical function member including a reflection portion and a transmission portion, which sectional optical function member is structured such that the deflection-controlled and condensed light beam is incident at the scanning means via one of the reflection portion and the transmission portion, and the other light beam which has been condensed without being deflection-controlled by the light-deflecting means is incident at the scanning means via the other of the reflection portion and the transmission portion,
wherein the scanning means, while maintaining a predetermined spacing in a sub-scanning direction between the light beams which are incident from the sectional optical function member, focuses the light beams onto a recording medium disposed at a support body of an inner drum and performs scanning for exposure.

15. The inner drum exposure apparatus of claim 14, further comprising:
a quarter-wavelength plate disposed downstream of the sectional optical function member, for converting the light beams emitted from the sectional optical function member to circularly polarized light; and
a uniaxial crystal disposed between the quarter-wavelength plate and the scanning means, for separating the circularly polarized light beams.

16. The inner drum exposure apparatus of claim 14, further comprising:
a polarizing beam splitter provided at an upstream side of the light-deflecting means, for polarizing and multiplexing two light beams to obtain a light beam which is incident at the light-deflecting means; and
a polarizing beam splitter provided at an upstream side of the sectional optical function member, for polarizing and multiplexing two light beams to obtain a light beam which is incident at the sectional optical function member, the obtained light beam being the light beam which has not been deflection-controlled by the light-deflecting means.

17. The inner drum exposure apparatus of claim 14, further comprising:
a quarter-wavelength plate, which converts the light beams emitted from the sectional optical function member to circularly polarized light;
another quarter-wavelength plate, which converts the circularly polarized light beams to light beams with mutually intersecting linear polarizations; and
a uniaxial crystal, which separates the light beams that have been converted by the other quarter-wavelength plate.

18. The inner drum exposure apparatus of claim 16, further comprising:
other light-deflecting means and an associated condensing lens, for performing deflection control of another two light beams; and
another sectional optical function member including a reflection portion and a transmission portion, which other sectional optical function member is structured such that the light beams from the other light-deflecting means and the associated lens are incident at the scanning means via one of the reflection portion and the transmission portion, and the light beams from the sectional optical function member are incident at the scanning means via the other of the reflection portion and the transmission portion of the other sectional optical function member.

19. The inner drum exposure apparatus of claim 14, wherein the sectional optical function member is formed with the transmission portion in an elliptical shape in plan view and the reflection portion being formed around the transmission portion, the transmission portion transmitting the light beam in a condensed state, and the reflection portion reflecting the light beam that has been deflection-controlled by the light-deflecting means in a condensed state.

20. The inner drum exposure apparatus of claim 14, wherein the sectional optical function member is formed with the reflection portion in an elliptical shape in plan view and the transmission portion being formed around the reflection portion, the reflection portion reflecting the light beam in a condensed state, and the transmission portion transmitting the light beam that has been deflection-controlled by the light-deflecting means in a condensed state.

21. The inner drum exposure apparatus of claim 14, wherein the sectional optical function member is divided in two with a linear boundary, one section thereof structuring the transmission portion for transmitting the light beam that is condensed thereat, and the other section thereof structuring the reflection portion for reflecting the light beam that is condensed thereat.
